(19) United States
(12) Patent Application Publication
(10) Pub. No.: US 2004/0166402 A1
(43) Pub. Date: Aug. 26, 2004

(54) Eternal light

(76) Inventors: John P. Zazzara SR., So. Plainfield, NJ (US); James J. Denker, Monmouth Beech, NJ (US)

Correspondence Address: JOHN P. ZAZZARA SR., 203 OAK MANOR PKWY., SO. PLAINFIELD, NJ, 07080, US

(21) Appl. No.: 10/370,003

(22) Filed: Feb. 21, 2003

(51) Int. Cl. H01M 2/10

(52) U.S. Cl. 429/97; 429/99; 429/123

(57) ABSTRACT

The Eternal Light consist of a Battery housing cylinder assembly to constructed from clear acrylic plastic. This houses a Battery guide assembly to be constructed from white acrylic plastic. The battery separator is vertically attached to the battery housing. The bottom end is capped with a steel bottom spring assembly (negative contact) with eight adjustable prongs A red permanent ink dot on steel bottom spring assembly is used to indicate correct orientation of left and right spring assemblies which constitute the negative contact points. The top housing cover switch assembly to be constructed from red acrylic plastic with center punched hole and side cut rectangle slot opening for a 2-pole mini-switch assembly Inserted into Housing cover assembly and anchored with epoxy glue from underside 0.4 AA batteries are inserted with positive (+) facing switch assembly to complete the assembly.

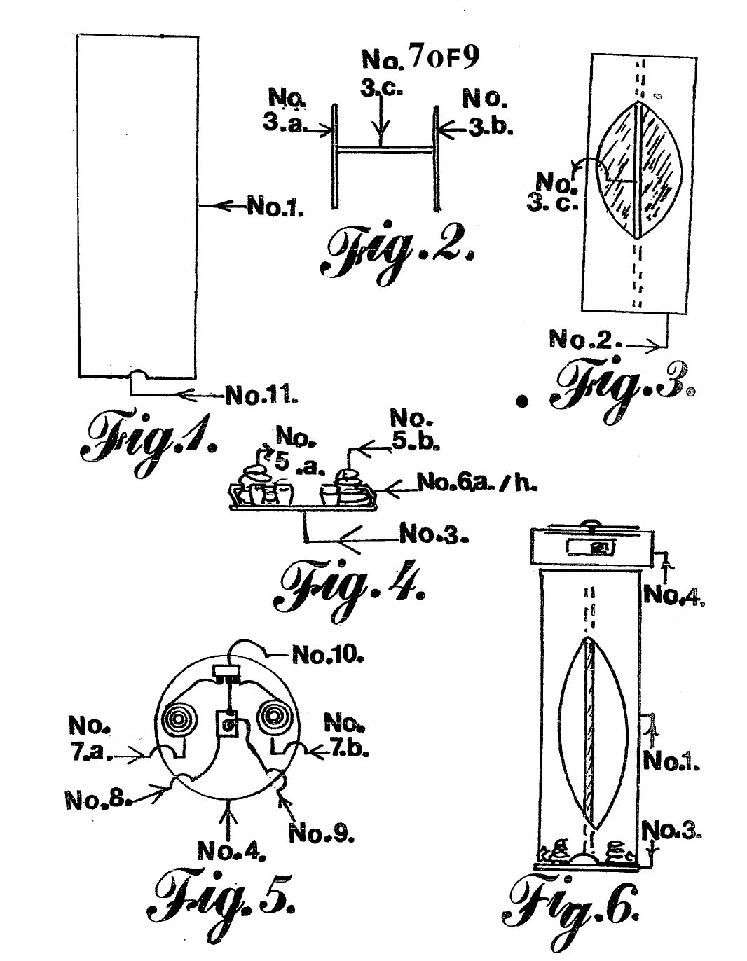

Battery hosing cylinder assembly to constructed from clear acrylic plastic as per FIG. 1 Length 4.050 inches, O.D. 1.035 inches, I.D.

1.0160. Cut out 0.25 inch radius notch in bottom of battery housing cylinder as per FIG. 1 front view. Battery guide assembly to be constructed from white acrylic plastic as per FIG. 2. top view 3a. Top view of battery guide frontal sub-assembly as per FIG. 2. 3b. Top view of battery guide rear sub-assembly as per FIG.2. 3c. Top view of battery guide center sub-assembly as per FIG. 2. Front view of battery guide assembly showing cutout view of 3c. battery separator vertically attached dead center to 3a and 3b as in FIG. 3. Side view of steel bottom spring assembly (negative contact) with eight adjustable prongs as per FIG. 4. 5a. Left spiral steel cone spring soldered to steel plate assembly as per FIG. 4. 5 windings from 0.360 to 0.018 diameter 5a. Right spiral steel cone spring soldered to steel plate assembly as per FIG. 4. 5 windings from 0.360 to 0.018 diameter 5b. Red permanent ink dot on steel bottom spring assembly to indicate correct orientation of left and right spring assemblies which constitute the negative contact points as per FIG. 4. Marking on No.3 to align with No.11 as in FIG. 1. Housing cover switch assembly 1.330 D, 0.050H and 0.048 T to be constructed from red acrylic plastic with center punched hole 0.0125 dead center. Extend from dead center to 0.055 and cut rectangle slot opening 0.313 L and 0.215 W. as per FIG. 5. Insert rivet of 0.0125D. over steel washer 0.125D and steel washer 0.621D into No.9 and insert from the bottom a rectangular steel retainer to hold rivet when compressed. The flat sides of the steel retainer when compressed to be oriented such that no contact is made between the spring assemblies as per FIG. 5. Solder 6a to pole No.2 the of 2-pole mini-switch assembly with 0.50 inch20 Ga copper wire. 6b. Insert 2-pole mini-switch assembly into Housing cover assembly No.6 and anchor with expoxy glue from underside of No.6 as per FIG. 5. 6c. Insert left spiral steel cone spring into underside of No.6 6c windings from 0.360 to 0.018 diameter. Solder 6c to pole No.1 the of 2-pole mini-switch assembly with 0.50 inch\20 Ga copper wire as per FIG. 5. 6d. Insert right spiral steel cone spring into underside of No.6 6d windings from 0.360 to 0.018 diameter. Solder 6d to pole No.3 the of 2-pole mini-switch assembly with 0.50 inch 20 Ga copper wire as per FIG. 5 Insert No.3 into No.1 with No.2 facing outward. Attach No 3 to the bottom of No.1 with red dot aligned with notch on No. 1. insert 4 AA batteries with positive (+) facing No.4. Attach No.4 to the top of No. 1 as per FIG. 6.

1. We claim that the external light battery assembly will allow for extended battery operation of any d sized flash light or other battery operated devices which accepts in-line d sized flash light batteries: The D sized batteries can now be replaced by 4 AA batteries in two separate chambers allowing power to be drawn from ether chamber A or chamber as selected by the user. Reserve power may be selected by switch over from the primary channel (A) to the reserve channel (B) therefore doubling the service life of the battery operated device.
